(19) United States
(12) Patent Application Publication
(10) Pub. No.: US 2011/0294350 A1
(43) Pub. Date: Dec. 1, 2011

(54) CONNECTORS WITH STEPPED INNER CAVITY

(75) Inventor: William R. Stagi, Burien, WA (US)

(73) Assignee: UTILX CORPORATION, Kent, WA (US)

(21) Appl. No.: 13/098,283

(22) Filed: Apr. 29, 2011

Related U.S. Application Data
(60) Provisional application No. 61/329,461, filed on Apr. 29, 2010.

(51) Int. Cl. H01R 9/11; H01R 43/048; H01R 43/28

(52) U.S. Cl. 439/623; 29/857; 29/863

(57) ABSTRACT

A connector or similar apparatus for connecting or terminating at least one cable or cable section is provided. The connector includes at least one stepped cavity for receiving a cooperatingly sized and configured stepped conductor end of the cable or cable section. The stepped cavity includes two or more adjoining cavity sections of decreasing diameter. After insertion of the stepped conductor end of the cable or cable section into the stepped cavity, the cable or cable section may be affixed to the connector via crimping or other suitable coupling techniques. Prior to insertion, the stepped conductor end is cleaned so as to remove oxidation, dirt and debris, and/or strand fill, etc.

### CROSS-REFERENCE(S) TO RELATED APPLICATION(S)

The present application claims the benefit of U.S. Provisional Application No. 61/329,461, filed Apr. 29, 2010, the disclosure of which is expressly incorporated by reference herein.

### BACKGROUND

Extensive networks of electrical power lines and cables are in place all over the world. Power lines and cables transport electric energy from, for example, power generating plants, to substations, distribution transformers, and ultimately to the end user.

The power lines and cables at various places along such distribution pathways may have many distinguishing characteristics depending on their intended voltage class and anticipated current load. However, regardless of their voltage and current rating, these cables and lines often share a common construction characteristic, i.e., a stranded conductor. In general, stranded conductors allow maximum flexibility for any given cross sectional conductor area. Whether insulated or not, stranded conductors, also referred to as conductor bundles, generally are concentric in design with a single central conductor strand surrounded by one or more layers of conductor stands.

Currently, methods exist to electrically connect two cable sections having stranded conductors. One known connection is shown in FIG. 1. As best shown in FIG. 1, the connection 10 includes a crimp style butt connector 14 which may be employed to couple a first stranded conductor bundle 16 of a first cable 20 to a second stranded conductor bundle 18 of a second cable 22. The free ends of the first and second conductors 16 and 18 are inserted into opposing connector bores 32 and 36, each having identical, constant diameters. After insertion of the free ends of the first and second conductors 16 and 18, the ends of the connector 14 are then crimped using a dedicated crimping tool thereby reducing the diameter of the connector 14 so that it tightly holds the stranded conductors 16 and 18. Usually the connector 14 is manufactured of sufficient length to allow multiple crimps along the stranded conductor's length.

With this connection method, there are several practical concerns that increase the electrical resistance from the inside conductor strands to the outer surface of the conductor bundle, reducing the effectiveness of the electrical connection. Firstly, oxidation layers on many types of conductor strand materials can form an immediate barrier to the free flow of current through the conductor bundle and into the connector body for transfer to the adjoining stranded conductor. Secondly, contaminants left behind by water and dust can infiltrate the layers of the stranded conductors and interfere with the free flow of current into the connector body. Thirdly, manufacturers routinely have placed cable-conductor sealing materials, known as strand fill, in-between the strands of the conductors. These materials have as their intent the blockage of water, and the contaminants which water carries throughout the strands. There are many varieties of materials in use, and many of such materials have been demonstrated to interfere with the free flow of current through the inner layers of the conductor bundle and into the connector body.

The current method of combating these concerns is to prepare the conductor bundle immediately before insertion into the connector. Such preparation usually includes wire brushing only the outermost layer for the removal of dirt debris and oxidation. Often, anti-oxidation treatments are then applied to the exposed outermost layer in advance of crimping. While this does enhance the conductivity between the outermost layer of the conductor bundle and the connector, this specifically leaves untreated the conductive path between each of the interior stranded layers. Of particular concern, it leaves untouched the cable-conductor sealing material, i.e., strand fill, which usually exists in the interstitial space between the interior conductor stands.

### SUMMARY

Embodiments disclosed herein are directed to devices and methods for addressing the problems set forth above, among others, by creating an unobstructed electrical pathway from the inside cable layers of a stranded conductor to the cable connector. In that regard, embodiments disclosed herein employ a connector having at least one interior cavity with a stepped configuration. In one embodiment, the diameter of the stepped cavity sections of the stepped cavity decrease in size as it extends into the interior of the connector. In several embodiments, the stepped cavity may include two, three, or four or more cavity sections of decreasing diameter. Cooperating in shape and size with the stepped cavity is an exposed stranded conductor having stepped sections with one or more strand layers removed. In one embodiment, prior to insertion in the stepped cavity of the connector, the stepped section of conductor can be prepared (e.g., removal of oxidation, dirt and debris, and/or strand fill, etc.) to remove potential barriers to the free flow of current from the stranded layers of the conductor to the connector.

In accordance with one aspect of the present disclosure, a connector is provided. The connector comprises an electrically conductive body having at least one free end, and a stepped cavity disposed at the at least one free end. The stepped cavity comprises at least two cavity sections, the first cavity section of the at least two cavity sections defining an opening for receiving a stranded conductor of a cable and the second cavity section of the at least two cavity sections positioned inwardly of and adjoining the first cavity section. The second cavity section has a smaller diameter than the first cavity section for receiving a reduced diameter portion of the stranded conductor.

In accordance with another aspect of the present disclosure, a connector is provided. The connector comprises an electrically conductive body having at least first and second stepped cavities. The at least first and second stepped cavities each comprise at least a first cavity section that defines an opening for receiving a conductive section of a cable and a second cavity section positioned inwardly of and adjoining the first cavity section. The second cavity section has a smaller diameter than the first cavity section for receiving a reduced diameter portion of the stranded conductive section of the cable.

In accordance with another aspect of the present disclosure, a method is provided for connecting a cable section to a connector. The connector comprises an electrically conductive body having a stepped cavity and the cable section comprises an exposed multilayered stranded conductor. The method comprises forming a stepped conductor end from the exposed multilayered stranded conductor of the cable section. The formed stepped conductor end is cooperatingly sized and configured to be received in the stepped cavity of the connector. The method also includes cleaning the stepped conductor end of the cable section, inserting the stepped conductor end of the cable section into the stepped cavity of the connector, and affixing the cable section to the connector.

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

### DESCRIPTION OF THE DRAWINGS

The foregoing aspects and many of the attendant advantages of this invention will become more readily appreciated by reference to the following detailed description, when taken in conjunction with the accompanying drawings, wherein:

FIG. 1 is a perspective view of a prior art connector for connecting two stranded power cables;

FIG. 2 is a perspective, longitudinal cross section view of one exemplary embodiment of a connector constructed in accordance with aspects of the present disclosure;

FIG. 3A is a perspective view of one exemplary embodiment of a cable section constructed in accordance with aspects of the present disclosure;

FIG. 3B is a perspective view of another exemplary embodiment of a cable section constructed in accordance with aspects of the present disclosure;

FIG. 3C is a cross sectional view of the cable section taken through lines 3C-3C in FIG. 3B;

FIG. 4 is shown a perspective view of one exemplary embodiment of a connector constructed in accordance with aspects of the present disclosure; and

FIG. 5A is a longitudinal cross sectional view of the connector shown in FIG. 4;

FIG. 5B is a longitudinal cross sectional view of another embodiment of a connector constructed in accordance with aspects of the present disclosure;

FIG. 6A is a perspective view of the connector of FIG. 4 affixed to first and second cable sections via crimping;

FIG. 6B is a cross sectional view of the connector taken through lines 6B-6B in FIG. 6A;

FIG. 7 is a longitudinal cross sectional view of another exemplary embodiment of a connector constructed in accordance with aspects of the present disclosure;

FIG. 8 is a longitudinal cross sectional view of another exemplary embodiment of a connector constructed in accordance with aspects of the present disclosure; and

FIG. 9 is a table showing results of various tests conducted on a number of connectors formed in accordance with the present disclosure and a number of prior art connectors.

### DETAILED DESCRIPTION

Embodiments of the present disclosure will now be described with reference to the drawings where like numerals correspond to like elements. Embodiments of the present disclosure are directed to connectors suitable for joining or splicing together at least two conductor bundles, terminating at least one conductor bundle, etc. Although exemplary embodiments of the present disclosure may be described hereinafter as suitable for interconnecting or splicing electrical power cables or cable sections, it will be appreciated that aspects of the present disclosure have wide application, and may be suitable for interconnecting or terminating other lines, cables or wires having stranded conductors. Accordingly, the following descriptions and illustrations herein should be considered illustrative in nature, and thus, not limiting the scope of the present disclosure. As used herein, the term cable or cable sections may include but are not limited to cables or cables sections, wires or wire sections, power lines or power line sections, etc.

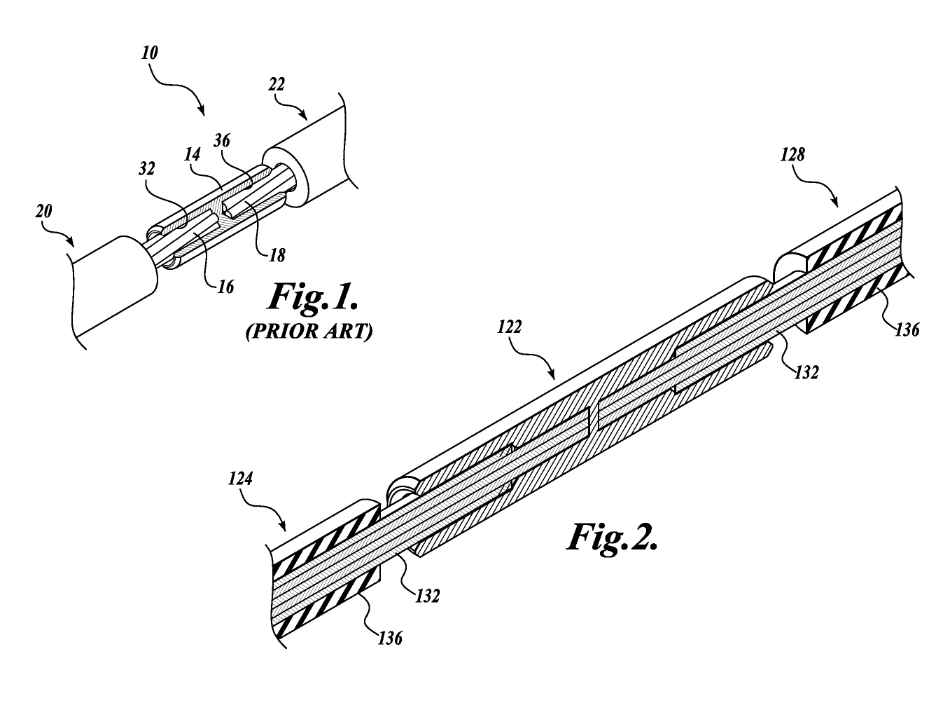

FIG. 2 illustrates a perspective, longitudinal cross section view of one exemplary embodiment of a connector 122 constructed in accordance with aspects of the present disclosure. In use, the connector 122 securely couples two cables or cable sections 124 and 128 in electrical communication.

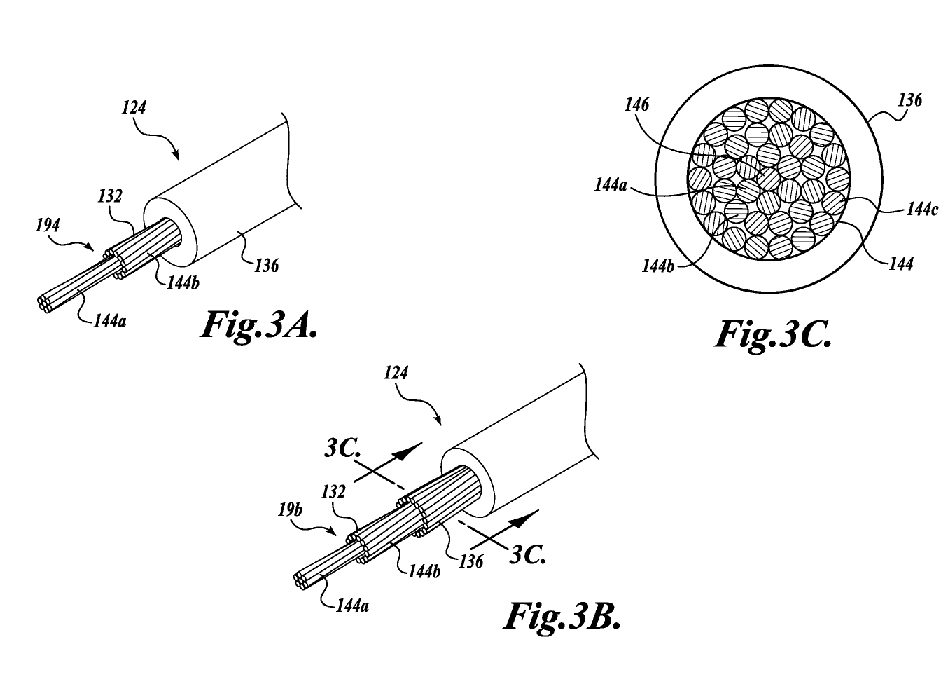

FIG. 3A is a perspective view of one example of a cable section 124 formed in accordance with aspects of the present disclosure. It will be appreciated that the cable section 128 can be constructed substantially similar to the cable section 124, and thus, will not be described in more detail. Like elements of the cable section 124 and 128 will use like numbers. In one embodiment, the cable or cable sections 124 and 128 each include a stranded conductor 132 and an outer protective layer 136.

In one embodiment, the stranded conductor 132 includes a plurality of electrically conductive strand layers 144a, 144b, etc., surrounding a central conductor strand 146 in a helical configuration. In the embodiment shown in the cross sectional view of FIG. 3C, the stranded conductor 132 includes a single, central conductor strand 146. Each successive layer 144a, 144b, 144c, etc., extending radially outwardly of the central conductor strand 146, is composed of a progression of six (6) additional cable strands (i.e., 6, 12, 18, 24 and so on) helically wrapped around the layer below it. It will be appreciated that other wrapping strategies and shapes for stranded conductor cores may be practiced with embodiments of the present disclosure. The strands of the conductor 132 are constructed of a suitable conductive material, such as copper, aluminum, etc. In some embodiments, a material, sometimes referred to as strand fill, is disposed in-between the strands for reducing the infiltration of water, etc., therein.

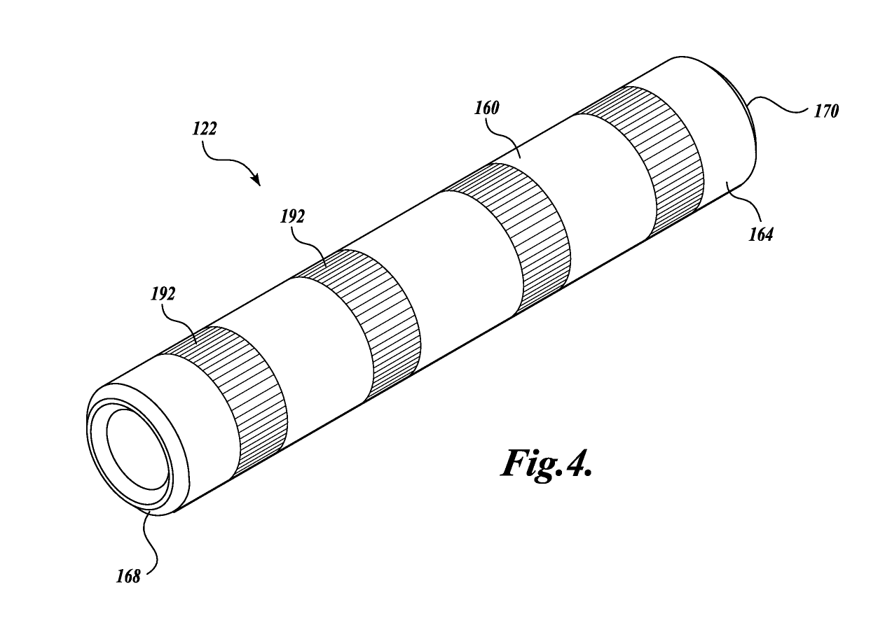

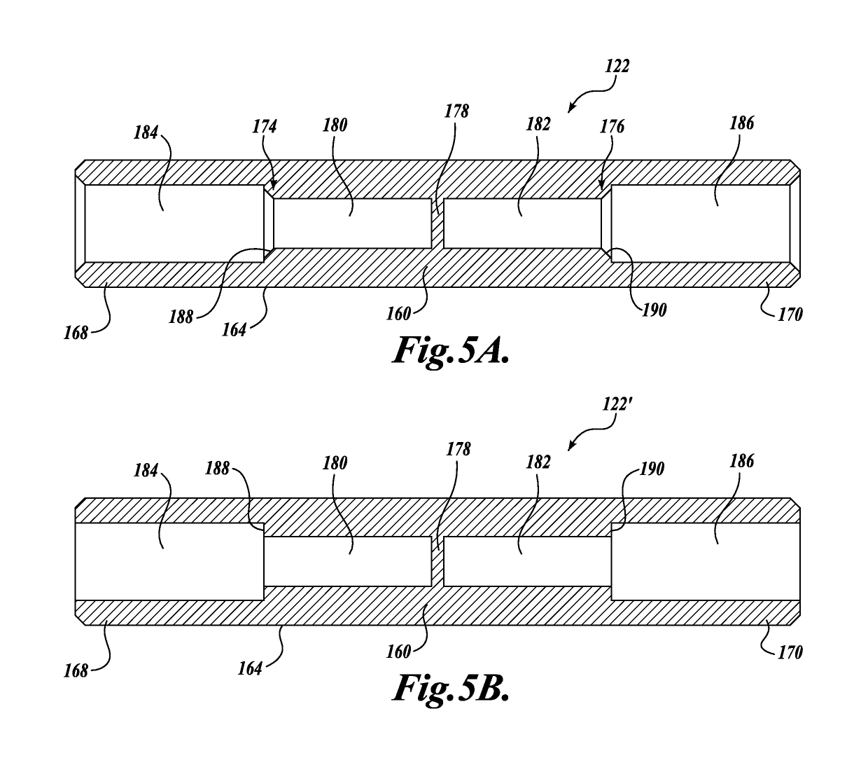

Referring now to FIGS. 4 and 5A, which are a perspective view and a longitudinal cross sectional view of the connector 122, respectively, the connector 122 will be described in more detail. As best shown in FIG. 4, the connector 122 includes a somewhat cylindrical connector body 160 constructed of electrically conductive material, such as aluminum or copper. The cable connector body 160 defines an exterior surface 164 and first and second ends 168 and 170. Referring to FIG. 5A, the connector body 160 further defines at least one stepped interior cavity, shown as opposing stepped interior cavities 174 and 176 that may be separated by an interior wall 178. In one embodiment, the stepped interior cavities 174 and 176 are defined by first cylindrical cavity sections 180 and 182, which are adjoined by second, larger dimensioned, cylindrical cavity sections 184 and 186. As such, shoulders 188 and 190 are formed as the diameter of the second cavity sections 184 and 186 transition to the diameter of the first cavity sections 180 and 182. Embodiments of the connector 122 may have interior cavities with chamfered shoulders (FIG. 5A) or without chamfered shoulders (FIG. 5B). The second cavity sections 186 and 188 are opened at the first and second ends 168 and 170 for receiving cooperatingly shaped ends of the conductor 132 of the cable or cable sections 124 and 128. When assembled, the ends of the conductor 132 of the cable or cable sections 124 and 128 have been inserted into their respective cavities, and affixed thereto by techniques such as crimping, soldering, adhesive bonding, etc., as shown in FIG. 2.

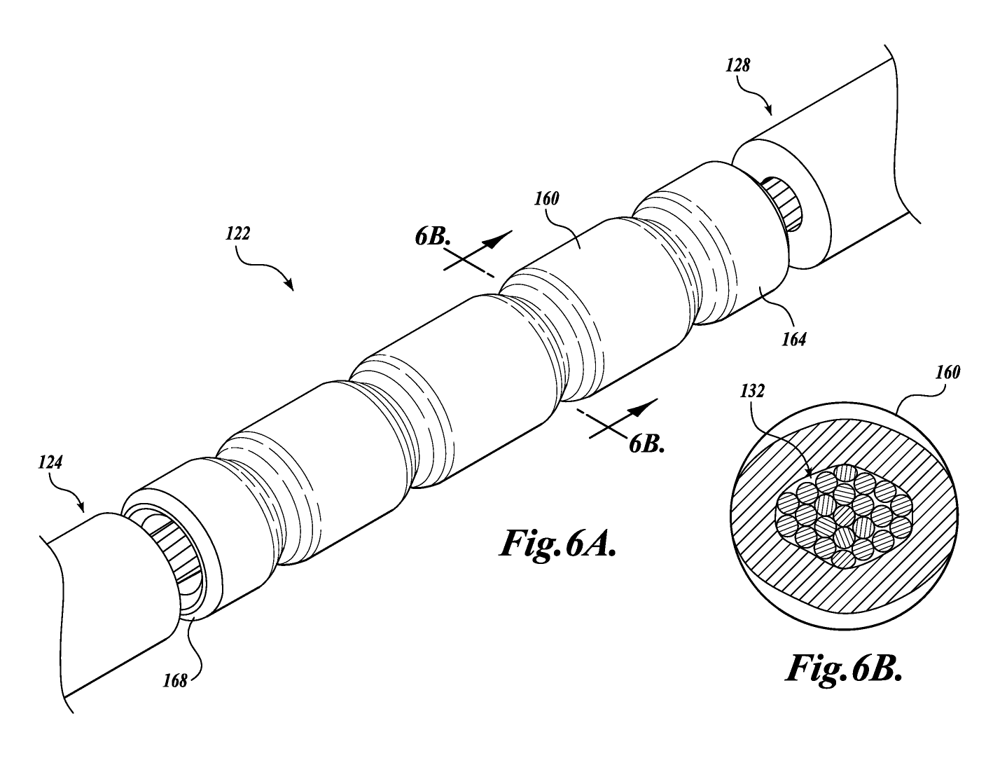

In one embodiment, the ends of the cable conductors 132 when inserted into the cavities 174 and 176 are then secured to the connector 122 by crimping each end 168 and 170 of the coupling, as best shown in FIGS. 6A and 6B. Crimping guides 192 may be provided on the exterior surface 164 of the body 160 to demark the appropriate location of crimping, as shown best in FIG. 4. Strain relief grooves (not shown) may be located on the exterior surface 164 of the connector 122 adjacent the crimping guides, respectively, and provide relief from strain forces generated as the connector is crimped.

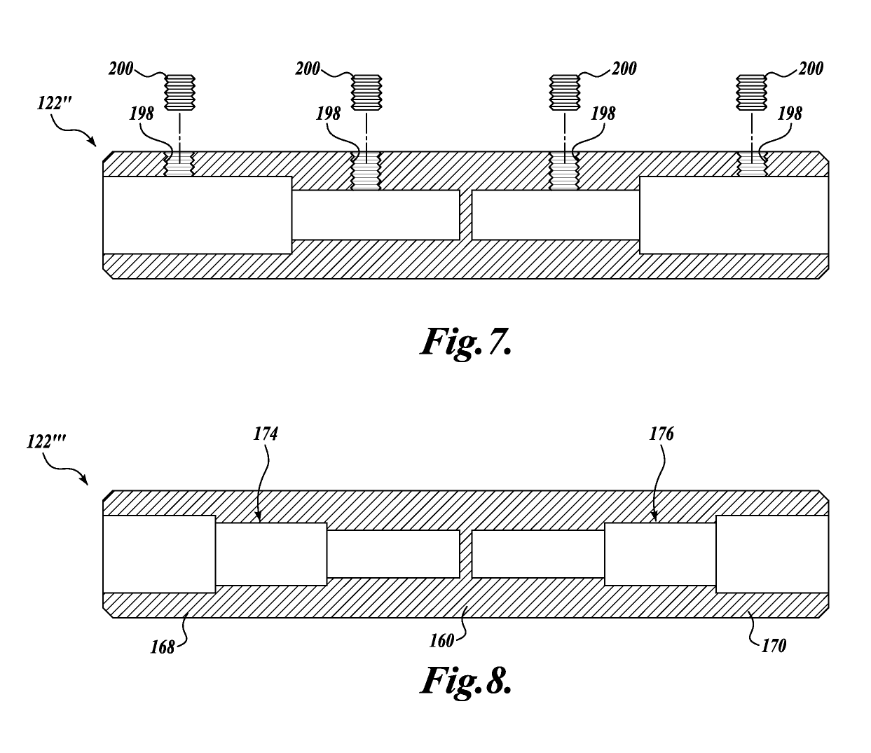

Other methods of affixing the conductor 132 to the connector 122 may be practiced with embodiments of the present disclosure. To that end, in another embodiment, the connector, designated 122″, may further include threaded openings 198 disposed along and perpendicular to its length, as best shown in FIG. 7. These threaded openings 198 accommodate threaded devices 200 to be screwed tightly onto the conductor bundle, thereby pressing the conductor bundle against the opposing side wall of the connector.

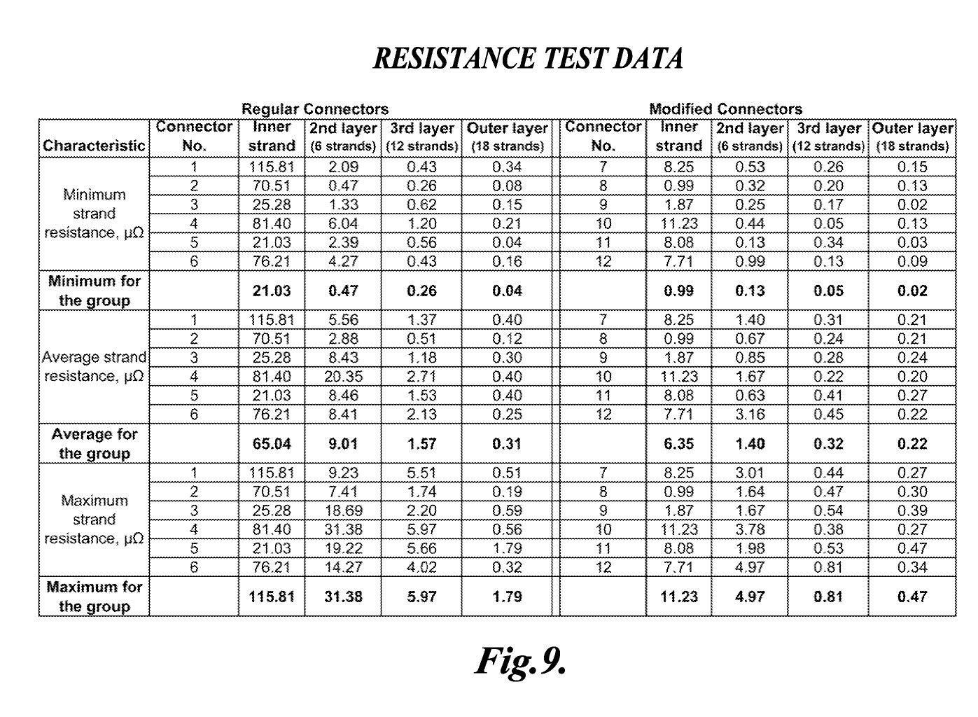

While the stepped interior cavities 174 and 176 are shown in FIG. 5 as including first and second cavity sections, any number of cavity sections may be provided with embodiments of the present disclosure. For example, the stepped interior cavities 174 and 176 of the conductor 122′″ shown in FIG. 8 include three (3) cavity sections. In other embodiments, each stepped interior cavity may include four (4) or more cavity sections. Other embodiments of the connector may have stepped interior cavities with unequal number of cavity sections.

In some embodiments of the present disclosure, the connector 122 may be utilized to splice two sections of medium voltage power cables. In these embodiments, the connector 122 is typically only a part of a larger splice assembly. In that regard, the splice assembly may also include other components, such as an encapsulating layer, seals, etc., not shown or described for brevity of this disclosure. One non-limiting example of a splice assembly that may employ the stepped cable connector 122 is described in U.S. Pat. No. 7,544,105, which is incorporated by reference herein.

One embodiment of connecting at least two cable or cable sections together using the connector 122 will now be described in detail. First, the loose or free ends of first and second cable sections are prepared so that they may be coupled together using the connector 122. To prepare the ends for coupling, the stranded conductor cores 132 are exposed. In one embodiment, the outer protective layer 136 is cut or stripped away. In other embodiments, an insulation layer, and/or other layers, such as neutral wires, an insulation shield, a strand shield, if employed, are stripped away to expose the conductor 132. Then, one or more of the top strand layers 144 along a portion of the cable sections is removed (e.g., cut away), leaving the stepped conductor end 194, such as that shown in FIG. 3A. In other embodiments, another one or more strand layers can be removed at an adjacent portion of the cable section, leaving the stepped conductor end 196, such as that shown in FIG. 3B.

Once the stepped conductor ends are formed, the stepped connectors can be cleaned. For example, any oxidation, dirt and debris, and/or strand fill, etc. built up on the stepped conductor ends 132 or the uppermost conductor layer may be removed. In one embodiment, an anti-oxidation treatment may be applied to the cleaned stepped connector ends 132. It will be appreciated that the exposed stranded conductor cores 132 may also be cleaned prior to forming the stepped connector, if desired. Cleaning the exposed stranded conductor cores 132 may include one or more of the following: removing any oxidation from the exposed stranded conductor cores 132; removing any strand fill from the exposed stranded conductor cores 132; removing any debris from the exposed stranded conductor cores 132.

The prepared stepped conductor ends of two cables, such as cable section 124 and cable section 128, are then inserted into the cooperatingly sized and configured cavities 174 and 176 of the connector 122. Next, the prepared stepped conductor ends of the cable sections are affixed to the connector 122. In one embodiment, the ends of the cable connector 122 are crimped over the stepped conductor ends, thereby affixing the conductors thereto.

It will be appreciated that the connector 122 is only one non-limiting example of a connector formed in accordance with aspects of the present disclosure, and that other connectors are within the scope of the claimed subject matter. In that regard, connectors within the scope of the claimed subject matter may generally include a connector having at least one end. Such connectors may include a termination, which may terminate one cable section or more than one cable section. Additionally, such connectors include connector 122 having two ends for connecting two somewhat co-linear cable sections, as well as connectors having two ends for connecting two cable sections at acute angles, obtuse angles, etc. Moreover, such connectors may including apparatus having three or more ends, such as Y, X, F, E, T connectors, among others, for connecting or terminating three or more cable sections. It will be further appreciated that such connectors may include at least one stepped interior cavity for receiving a cooperating sized and configured stepped cable conductor end(s). The at least one stepped interior cavity comprises two or more cavity sections.

Tests have been conducted to demonstrate the reduction in resistance when coupling stranded conductors using embodiments of the present disclosure instead of conventional connection methods. The tests were conducted on six (6) test samples comprising identical 37 strand conductor bundles. Those strands are arranged as a central conductor surrounded by three (3) additional layers of stranding, as best shown in FIG. 3C. The strands contained a strand filling material. The conductor bundles were crimped within a connector like that depicted in FIG. 8, having three (3) cavity sections on each connector end. The tests were also conducted on six (6) test samples comprised of the identical 37 strand conductor bundles, crimped within standard connectors (such as the connector 14 shown in FIG. 1). Resistance measurements were taken between the individual conductor strands of the various layers, and the connector itself. For each layer the minimum strand resistance was recorded, the maximum strand resistance was recorded and the average of the entire layers conductor strands was recorded. These three data were repeated for all 12 samples. In all cases, the resistance is recorded in micro-ohms. The results of the tests are depicted in FIG. 9.

As shown in FIG. 9, the test results relating to the outer layer of both the conventionally prepared cables and the cables prepared in accordance with the method of this disclosure are nearly equal. This is as one would expect since the preparation of the outer layers are virtually identical and in both cases the outer layers are in direct contact with the connector wall. However, as you move into the next inner layer of conductors, the advantage begins to show. The average resistance between the conductors in the 3^{rd} strand layer (the layer nearest the outer most layer) and the connector body of the conventionally treated conductor bundle is 490% or almost five times greater than the same value in the conductor bundle treated in accordance with aspects of this disclosure. By the 2^{nd} layer of conductor strands, the average resistance difference has increased to 640%, meaning that the 2^{nd} layer of the conventionally treated conductor bundle is has nearly six and a half times greater resistance. This trend continues to the innermost single strand in the conductor bundles where the difference between the higher resistance of the conventionally treated cable and the cables treated in accordance with this disclosure reaches a difference of 1,024%. In other words, the current trying to travel up from the innermost conductor strand and into the connector body has to contend with nearly 10.25 times more resistance than its counterpart—the innermost conductor strand of the conductor bundle treated in accordance with aspects of this disclosure.

Increased resistance creates dramatic increases in heat as the square of the current is converted to heat across the resistance. That increased heat further increases the resistance between the conductor strands between the conductor layers. The result can lead to thermal runaway and connection failure when cables become heavily loaded.

The principles, representative embodiments, and modes of operation of the present disclosure have been described in the foregoing description. However, aspects of the present disclosure which are intended to be protected are not to be construed as limited to the particular embodiments disclosed. Further, the embodiments described herein are to be regarded as illustrative rather than restrictive. It will be appreciated that variations and changes may be made by others, and equivalents employed, without departing from the spirit of the present disclosure. Accordingly, it is expressly intended that all such variations, changes, and equivalents fall within the spirit and scope of the present disclosure.

The embodiments of the invention in which an exclusive property or privilege is claimed are defined as follows:

1. A connector, comprising:
an electrically conductive body having at least one free end;
a stepped cavity disposed at the at least one free end, the stepped cavity comprising at least two cavity sections, the first cavity section of the at least two cavity sections defining an opening for receiving a stranded conductor of a cable and the second cavity section of the at least two cavity sections positioned inwardly of and adjoining the first cavity section, the second cavity section having a smaller diameter than the first cavity section for receiving a reduced diameter portion of the stranded conductor.

2. The connector of claim 1, wherein the stepped cavity comprises three or more adjoining cavity sections.

3. The connector of claim 1, wherein the electrically conductive body includes at least two free ends.

4. The connector of claim 3, wherein the at least two free ends each include a stepped cavity, each stepped cavity comprising at least two cavity sections, the first cavity section of the at least two cavities defining an opening for receiving a stranded conductor of a cable and the second cavity section of the at least two cavities positioned inwardly of and adjoining the first cavity section, the second cavity section having a smaller diameter than the first cavity section for receiving a reduced diameter portion of the stranded conductor.

5. The connector of claim 1, wherein the free end of the body is constructed out of a material capable of being crimped.

6. The connector of claim 5, further comprising crimping guides disposed on the exterior surface of the at least one free end.

7. The connector of claim 1, wherein the electrically conductive body further includes at least two threaded bores and at least two male threaded devices, each threaded bore disposed orthogonal to the central axis of the stepped cavity and opening into one of the at least two cavity sections, and wherein each male threaded device is threadedly received by one of the at least two threaded bores for binding and electrically connecting the stranded conductive section of the cable with an inner side wall of the respective cavity section.

8. A cable connector, comprising:
an electrically conductive body having at least first and second stepped cavities, the at least first and second stepped cavities each comprising at least a first cavity section that defines an opening for receiving a conductive section of a cable and a second cavity section positioned inwardly of and adjoining the first cavity section, the second cavity section having a smaller diameter than the first cavity section for receiving a reduced diameter portion of the stranded conductive section of the cable.

9. The cable connector of claim 8, wherein the first cavity section has a constant diameter.

10. The cable connector of claim 8, wherein the second cavity section has a constant diameter.

11. The cable connector of claim 8, wherein the electrically conductive body further includes at least two threaded bores and at least two male threaded devices, each threaded bore disposed orthogonal to the central axis of a stepped cavity and opening into one of the first and second cavity sections, and wherein each male threaded device is threadedly received by one of the at least two threaded bores for binding and electrically connecting the stranded conductive section of the cable with an inner side wall of the respective cavity section.

12. The cable connector of claim 8, wherein a portion of the electrically conductive body associated with the at least first and second stepped cavities is capable of being crimped so as to couple and electrically connect the stranded conductive section of the cable with at least one inner side wall of the respective cavity section.

13. The cable connector of claim 12, further comprising crimping guides disposed on the exterior surface of the electrically conductive body.

14. A method of connecting a cable section to a connector, wherein the connector comprises an electrically conductive body having a stepped cavity and wherein the cable section comprises an exposed multilayered stranded conductor, the method comprising:
forming a stepped conductor end from the exposed multilayered stranded conductor of the cable section, the formed stepped conductor end cooperatingly sized and configured to be received in the stepped cavity of the connector;
cleaning the stepped conductor end of the cable section;
inserting the stepped conductor end of the cable section into the stepped cavity of the connector;
affixing the cable section to the connector.

15. The method of claim 14, wherein affixing the stepped conductor end to the connector includes
crimping a portion of the body of the connector to the stepped conductor end of the cable section.

16. The method of claim 14, wherein affixing the stepped conductor end to the connector includes
tightening at least two threaded devices against the stepped conductor end.

17. The method of claim 14, wherein forming a stepped conductor end from the exposed multilayered stranded conductor of the cable section includes
removing at least the top stand layer of the multilayered stranded conductor along a portion of the cable section.

18. The method of claim 17, wherein cleaning the stepped conductor end includes one or more of:
removing any oxidation from the stepped conductor end;
removing any strand fill from the stepped conductor end;
removing any debris from the stepped conductor end.

19. The method of claim 14, further comprising
cleaning the exposed multilayered stranded conductor prior to forming the stepped conductor end.

20. The method of claim 19, wherein cleaning the exposed multilayered stranded conductor includes one or more of:
removing any oxidation from the exposed multilayered stranded conductor;
removing any strand fill from the exposed multilayered stranded conductor;
removing any debris from the exposed multilayered stranded conductor.
